(19) United States
(12) Patent Application Publication
(10) Pub. No.: US 2005/0146490 A1
(43) Pub. Date: Jul. 7, 2005

(54) Display device drive methods and systems and display devices incorporating same

(76) Inventors: Won Sik Kang, Gyeonggi-do (KR); Jae Goo Lee, Gyeonggi-do (KR)

Correspondence Address: Timothy J. O'Sullivan;Myers Bigel Sibley & Sajovec, Post Office Box 37428, Raleigh, NC, 27627, US

(21) Appl. No.: 10/863,829

(22) Filed: Jun. 8, 2004

(30) Foreign Application Priority Data
Jan. 5, 2004 (KR) 10-2004-0000360

(51) Int. Cl. G09G 5/00

(52) U.S. Cl. 345/76

(57) ABSTRACT

Lines of a display device are scanning in an overlapping block-wise fashion. For example, gate lines of a display device are driven in an overlapping block-wise fashion. Gate lines may be driven where a block of gate lines are consecutively driven with the same polarity and the polarity inverted to drive a subsequent block of gate lines. The blocks of gate lines overlap in that a range of gate lines of a first block overlaps with a range of gate lines of a second block. Methods and systems for driving gate lines in an overlapping block-wise fashion are also provided.

### CLAIM OF PRIORITY

This application claims priority from Korean Patent Application No. 2004-0000360, filed on Jan. 5, 2004 in the Korean Intellectual Property Office, the contents of which are hereby incorporated by reference in their entirety as if set forth fully herein.

### FIELD OF THE INVENTION

The present invention relates to displays and, more particularly, to driving gate lines of display devices.

### BACKGROUND OF THE INVENTION

In order to minimize the space required by display devices, research into the development of various flat panel display devices, such as LCD display devices, plasma display panels (PDP) and electro-luminescence displays (EL), has been undertaken to displace larger cathode-ray tube displays (CRT) as the most commonly used display devices. Particularly, in the case of LCD display devices, liquid crystal technology has been explored because the optical characteristics of liquid crystal material can be controlled in response to changes in electric fields applied thereto.

Liquid crystal display devices (LCD) and panels are typically based on thin film transistor (TFT) technologies. Using these technologies, high quality image displays of substantial size can be fabricated using low temperature processes. As will be understood by those skilled in the art, conventional LCD devices typically include a transparent (e.g., glass) substrate with an array of thin film transistors thereon, pixel electrodes, orthogonal gate and data lines, a color filter substrate and liquid crystal material between the transparent substrate and color filter substrate. The use of TFT technology typically also requires the use of separate peripheral integrated circuitry to drive the gates and sources (i.e., data inputs) of the TFTs in the array.

Active matrix liquid crystal displays include a matrix of pixels that each include red, green and blue cells. Each cell has a transistor that controls the operations of the cell. Cells in the same line of the display typically have the gate electrode of their transistors commonly connected by a gate line. Cells in the same column typically have their source electrodes commonly connected by a source line. Thus, each cell of each pixel may be individually addressable through selection of a gate line and a source line.

One consideration in the operation of a display device, such as a liquid crystal display, is that the liquid crystal may deteriorate if the electric field applied to the liquid crystal is always applied in the same direction. Therefore, liquid crystal displays typically periodically invert the polarity of the electric field applied to a gate of the display so as to reduce the deterioration of the liquid crystal. This inversion may, for example, be provided by changing the common voltage applied to the liquid crystal panel and appropriately changing the gate voltage applied to the gate lines of the liquid crystal display. Conventionally, several techniques have been used to accomplish this inversion and include frame inversion, line inversion and n-line inversion. Each of these inversion methods is described in further detail below.

Frame inversion typically provides the same polarity for all gate lines in a frame. That polarity is then inverted on a subsequent frame. FIG. 1 illustrates an example of frame inversion. As seen in FIG. 1, each of the gate lines are positive in frame N and are inverted to negative in frame N+1. Thus, the voltage V_{com} that reflects the polarity of the gate drive signal changes once per frame as illustrated in FIG. 1. Frame inversion, however, may result in noticeable flicker of the display. Flicker may result because the light transmission of liquid crystal display is not the same for the two polarities. The difference in light transmission between the two polarities may be noticeable as flicker because the entire frame changes from a bright frame to a darker frame with each successive frame.

To reduce flicker in a display, line inversion has been utilized. FIG. 2 illustrates an example of line inversion. In line inversion, every other line in a frame has an opposite polarity. That polarity is then inverted on a line-by-line basis in each subsequent frame. Thus, as seen in FIG. 2, in frame N, the first line is driven with a positive polarity and the polarity is inverted to drive the second line with a negative polarity. The polarity is inverted to drive the third line with a positive polarity and again inverted to drive the fourth line with a negative polarity. In frame N+1, the polarity inversions are the opposite of those in frame N. Thus, the first line is driven with a negative polarity, the second line is driven with a positive polarity, the third line is driven with a negative polarity and the fourth line is driven with a positive polarity. These changes in polarity are reflected in V_{com} of FIG. 2.

Line inversion may reduce flicker because the average brightness of the display is the same from frame to frame and the size of each scan line is typically below the threshold at which the human eye can distinguish the difference in light transmission of the alternating frames when viewed from a typical viewing distance. However, because the driver circuit switches polarity with each scan line, the line inversion method may require more power than the frame inversion method as the amount of power needed to drive the gate lines of the display is typically proportional to the number of changes in polarity.

To reduce power consumption while reducing flicker, n-line inversion has been used. FIG. 3 illustrates n-line inversion where n is three. In n-line inversion, every other n consecutive lines in a frame have an opposite polarity. The polarity of each n-lines is then inverted in each subsequent frame. Thus, as seen in FIG. 3, in frame N, the first three lines are driven with a positive polarity and the polarity is inverted to drive the next three lines with a negative polarity. The polarity is inverted to drive the third set of three lines with a positive polarity and again inverted to drive the fourth set of three lines with a negative polarity. In frame N+1, the polarity inversions are the opposite of those in frame N. Thus, the first three lines are driven with a negative polarity, the second set of three lines are driven with a positive polarity, the third set of three lines are driven with a negative polarity and the fourth set of three lines are driven with a positive polarity. These changes in polarity are reflected in V_{com} of FIG. 3.

N-line inversion may reduce power consumption with respect to line inversion because the number of changes in polarity is reduced over that in line inversion. Furthermore, n-line inversion may reduce flicker with respect to frame inversion because sets of n lines within a frame have opposite polarity. However, flicker may still be detectable in a display using n-line inversion and may become more noticeable as n is increased.

FIG. 4 is a graph illustrating power consumption utilizing frame inversion, n-line inversion and line inversion techniques. As seen in FIG. 4, line inversion consumes 1.85 mA per frame. Frame inversion consumes 1.35 mA per frame. When n is two, n-line inversion consumes 1.60 mA per frame and when n is three, n-line inversion consumes 1.47 mA per frame. As n is increased, the power consumption approaches that of frame inversion.

### SUMMARY OF THE INVENTION

Embodiments of the present invention provide for scanning of lines of a display in an overlapping block-wise fashion, for example, by driving gate lines of a display device in an overlapping block-wise fashion utilizing non-contiguous blocks of gate lines. Such embodiments may include methods and/or systems for driving gate lines of a display device.

In certain embodiments of the present invention, the gate lines in the blocks of gate lines include only non-adjacent gate lines of the display device. Furthermore, two consecutive blocks of gate lines may include at least one gate line from each of the two blocks that are adjacent gate lines. Also, polarity of the gate lines of consecutive blocks of gate lines may be inverted for a frame displayed on the display device. Polarity of the gate lines of a block of gate lines may be inverted for consecutive frames displayed on the display device. Individual blocks of the blocks of gate lines may include less than half a total number of gate lines of the display.

In further embodiments of the present invention, blocks of gate lines include n gate lines and the gate lines are spaced apart by k gate lines, where n≧2 and k≧1. In certain embodiments, n=3 and k=1.

In additional embodiments of the present invention, data corresponding to a driven gate line is provided from a memory for driving a source line associated with the driven gate line in a sequence of the overlapping block-wise fashion. The data stored in memory may be stored in a sequence of the overlapping block-wise fashion or read from memory in the sequence of the overlapping block-wise fashion. The data stored in memory may be written to or read from memory by translating an address j′ that increments from 1 to 2n, where n is the number of lines in a block, to provide a new address d, wherein the address translation comprises translating a first sequence of addresses corresponding to a first block utilizing a first count j, where
d=j′+(j−1), for j=1 to n and j′=1 to n; and
translating a second sequence of addresses corresponding to a second block utilizing the first count j, where
d=j′−(j−1), for j=n to 1 and j′=n+1 to 2n.

In some embodiments of the present invention, the display device includes a liquid crystal display. The display device could also include an organic light emitting device (OLED).

In yet other embodiments of the present invention, a system for controlling operation of a display device includes a source driver circuit configured to receive data and to drive source lines of the display device based on the received data, a gate driver circuit configured to selectively drive gate lines of the display device, and a timing controller circuit. The timing controller circuit is configured to receive data for display in the display device, to control the gate driver circuit to selectively drive the gate lines in an overlapping block-wise fashion utilizing non-contiguous blocks of gate lines and to provide the received data corresponding to driven gate lines to the source driver circuit.

In further embodiments of the present invention, the timing controller circuit is further configured to control a drive voltage generator to invert polarity of the gate lines of consecutive blocks of gate lines for a frame displayed on the display device. The timing controller circuit may be further configured to control a drive voltage generator to invert polarity of the gate lines of a block of gate lines for consecutive frames displayed on the display device. The timing controller circuit may be further configured to control a drive voltage generator to invert polarity of the gate lines of a block of gate lines for consecutive frames displayed on the display device.

In additional embodiments of the present invention, the timing controller includes a memory address modifier circuit configured to receive a memory scan address, alter the address according to a sequence of the overlapping block-wise fashion and provide the altered address to a memory so as to store and/or retrieve data for display in the memory in the sequence of the overlapping block-wise fashion. The timing controller also includes a line sequence modifier circuit configured to receive a gate line identifier and alter the gate line identifier according to the sequence of the overlapping block-wise fashion and to provide the altered gate line identifier to the gate driver circuit. The memory address modifier circuit may be configured to translate the memory scan address j′ that increments from 1 to 2n, where n is the number of lines in a block, to provide an altered address d, wherein the address translation translates a first sequence of addresses corresponding to a first block utilizing a first count j, where
d=j′+(j−1), for j=1 to n and j′=1 to n; and
translates a second sequence of addresses corresponding to a second block utilizing the first count j, where
d=j′−(j−1), for j=n to 1 and j′=n+1 to 2n.

The memory address modifier circuit may include a first inverter that receives a first input bit of the memory scan address, a second inverter that receives a second input bit of the memory scan address and a third inverter that receives a third input bit of the memory scan address. A first NAND gate receives an output of the first inverter and the second input bit. A second NAND gate receives an output of the second inverter and the first input bit. A third NAND gate receives an output of the third inverter and the output of the second inverter. A fourth NAND gate receives an output of the first NAND gate and an output of the second NAND gate. A fifth NAND gate receives the third input bit and the second input bit. A sixth NAND gate receives an output of the third NAND gate and the output of the first inverter. A seventh NAND gate receives the first input bit, the second input bit and the third input bit. An eighth NAND gate receives an output of the fourth NAND gate and the output of the third inverter. A ninth NAND gate receives the output of the fourth NAND gate and the third input bit. A tenth NAND gate receives an output of the fifth NAND gate and an output of the sixth NAND gate and output a first output bit of the altered address. An eleventh NAND gate receives an output of the seventh NAND gate and an output of the eighth NAND gate and outputs a second output bit of the altered address. A twelfth NAND gate receives the output of the seventh NAND gate and an output of the ninth NAND gate and outputs a third output bit of the altered address.

In further embodiments of the present invention, gate lines of a display device are driven by driving a first subset of the gate lines of the display device, the first subset including a plurality of non-adjacent gate lines and then driving a second subset of the gate lines, the second subset including a plurality of gate lines adjacent the gate lines of the first subset. Polarity of the voltage applied to the gate lines in the first subset and the gate lines in the second subset is inverted.

In some embodiments of the present invention, at least one of the second subset of gate lines is interspersed with gate lines in the first subset of gate lines. Additionally, the polarity of the voltage applied to the gate lines of the first subset of gate lines may be inverted from a polarity of the voltage applied to the gate lines of the first subset of gate lines during a previous frame and the polarity of the voltage applied to the gate lines of the second subset of gate lines may be inverted from a polarity of the voltage applied to the gate lines of the second subset of gate lines during the previous frame.

Additional embodiments of the present invention may provided for driving gate lines of a display device by dividing the gate lines of the display device into blocks of non-adjacent gate lines having k gate lines between gate lines in the block and having n non-adjacent gate lines in a block, inverting a polarity of a voltage applied to consecutively driven ones of the blocks of non-adjacent gate lines and inverting the polarity applied to the blocks of non-adjacent gate lines on consecutive frames of data for display on the display device. In certain embodiments, k is one and n is three.

### BRIEF DESCRIPTION OF THE DRAWINGS

FIG. 1 is a diagram of two consecutive frames illustrating frame inversion;

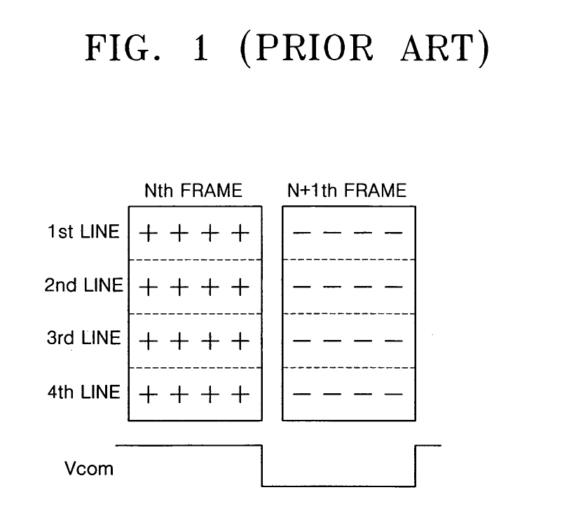

FIG. 2 is a diagram of two consecutive frames illustrating line inversion;

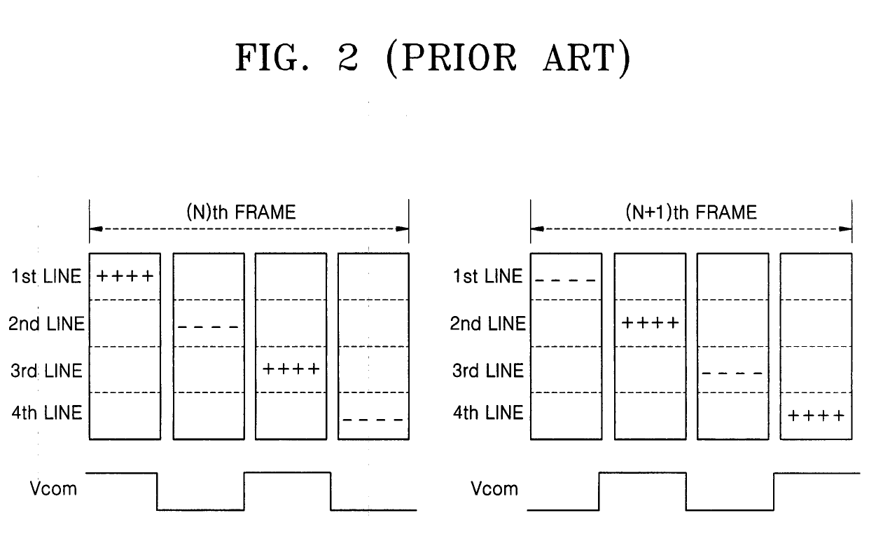

FIG. 3 is a diagram of two consecutive frames illustrating n-line inversion;

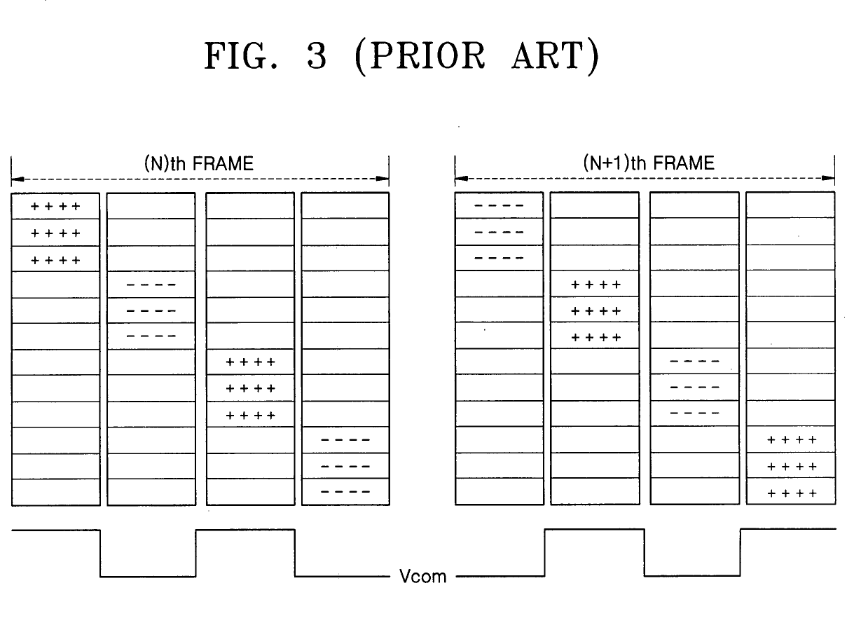

FIG. 4 is a graph of power consumption for frame inversion, n-line inversion and line inversion;

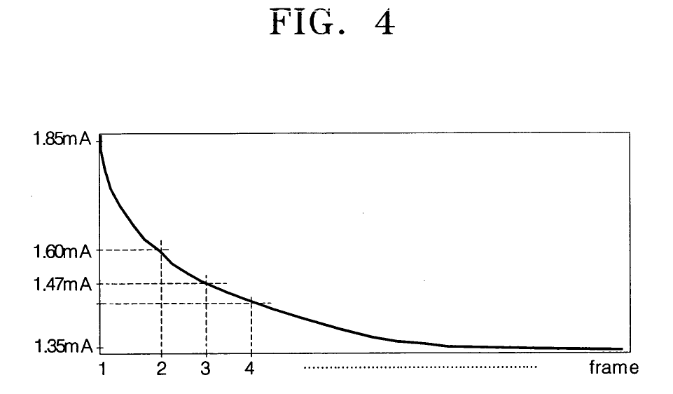

FIG. 5 is a diagram of two consecutive frames illustrating overlapping block-wise inversion according to particular embodiments of the present invention;

FIG. 6 is a block diagram of a display system according to certain embodiments of the present invention;

FIG. 7 is a block diagram of a timing controller according to certain embodiments of the present invention; and

FIG. 8 is a block diagram of an address generator circuit according to some embodiments of the present invention.

### DETAILED DESCRIPTION OF THE INVENTION

The present invention will now be described more fully with reference to the accompanying drawings, in which embodiments of the invention are shown. This invention may, however, be embodied in different forms and should not be construed as being limited to the embodiments set forth herein. Rather, these embodiments are provided so that this disclosure will be thorough and complete, and will fully convey the scope of the invention to those skilled in the art. In the drawings, the size or thickness of layers and regions are exaggerated for clarity. Like numbers refer to like elements. As used herein the term “and/or” includes any and all combinations of one or more of the associated listed items.

It will be understood that although the terms first and second may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first region, layer, or section discussed below could be termed a second region, layer, or section, and similarly without departing from the teachings of the present invention.

Embodiments of the present invention provide for driving gate lines in an overlapping block-wise fashion. Thus, gate lines are driven where a block of gate lines are consecutively driven with the same polarity and the polarity inverted to drive a subsequent block of gate lines. The blocks of gate lines overlap in that a range of gate lines of a first block overlaps with a range of gate lines of a second block. As discussed herein, gate lines are referred to by an address or identifier of the gate lines where adjacent gate lines in a display device have consecutive addresses (identifiers). Thus, by stating that the range of gate lines of two blocks overlaps it indicates that the physical location of the gate lines in the display device and, accordingly, the pixels controlled by the gate lines are interspersed with one another. The spacing between gate lines in a block of gate lines may be uniform or non-uniform.

In particular embodiments of the present invention, the blocks include n lines that have a uniform k line spacing between consecutive lines in the block. In such embodiments, k+1 consecutive blocks will be overlapping. Thus, if k is one, two consecutive blocks will be overlapping and if k is two, three consecutive blocks will be overlapping. Other schemes of overlapping blocks may be utilized while still benefiting from the teachings of the present invention.

In certain embodiments, the polarity of corresponding blocks is inverted over m frames, where m≧1. In particular embodiments of the present invention, the polarity of corresponding blocks in consecutive frames is inverted (i.e. m=1).

By driving gate lines in overlapping blocks, some of the benefit of line inversion may be provided in that flicker may be reduced over use of the n-line inversion with a corresponding number of lines of the same polarity being driven, without increasing power consumption over that of the corresponding n-line inversion.

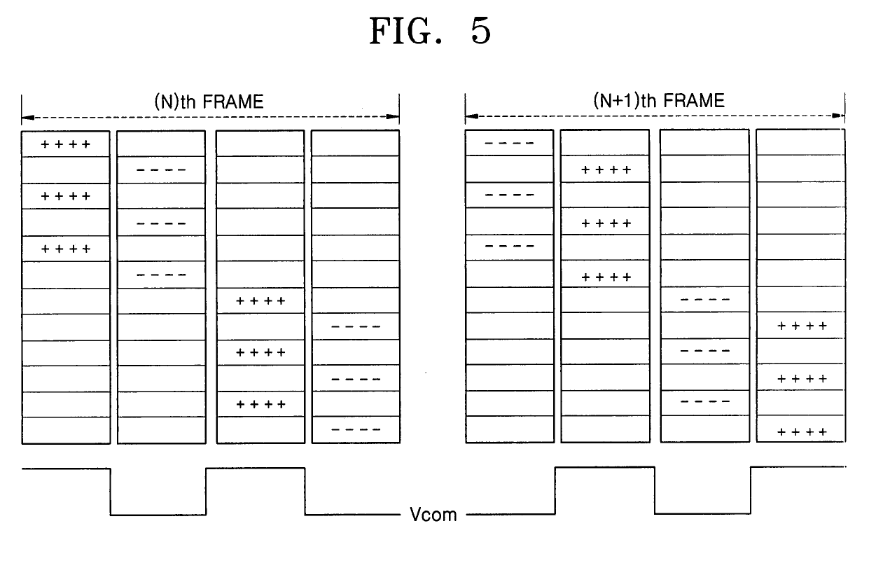

FIG. 5 is a diagram illustrating consecutive frames where gate lines are driven in an overlapping block-wise fashion. In FIG. 5, k is one and n is three. As seen in FIG. 5, the first, third and fifth lines of frame N are driven with a positive polarity and provide a first block of gate lines. The range of gate lines provided in the first block is from one to five. The second, fourth and sixth gate lines are then driven with a negative polarity and provide a second block of gate lines. The range of gate lines provided in the second block of gate lines is from two to six. Thus, the range of gate lines in the first block overlap with the range of gate lines in the second block.

A third block of gate lines includes lines seven, nine and eleven and a fourth block of gate lines includes lines eight, ten and twelve. The third block is driven with a positive polarity in frame N and the fourth block is driven with a negative polarity in frame N. This division of the frame is repeated until all of the gate lines in the display have been assigned a block. Consecutive blocks have opposite polarity and the polarity of a block in frame N is inverted in frame N+1. Thus, unlike conventional frame, line inversion and n-line inversion where gate lines are sequentially addressed, gate lines according to embodiments of the present invention are non-sequentially addressed.

Table 1 below illustrates the addressing sequence for k=1 and n=3 for an x by y display where y is a positive integer divisible by three.

TABLE 1
Exemplary Gate Line Addressing Sequence

| Block # | Drive Sequence # | Gate Line Address |
|---|---|---|
| 1 | 1 | 1 |
| 1 | 2 | 3 |
| 1 | 3 | 5 |
| 2 | 4 | 2 |
| 2 | 5 | 4 |
| 2 | 6 | 6 |
| . | . | . |
| . | . | . |
| . | . | . |
| (y/3)-1 | y-5 | y-5 |
| (y/3)-1 | y-4 | y-3 |
| (y/3)-1 | y-3 | y-1 |
| y/3 | y-2 | y-4 |
| y/3 | y-1 | y-2 |
| y/3 | y | y |

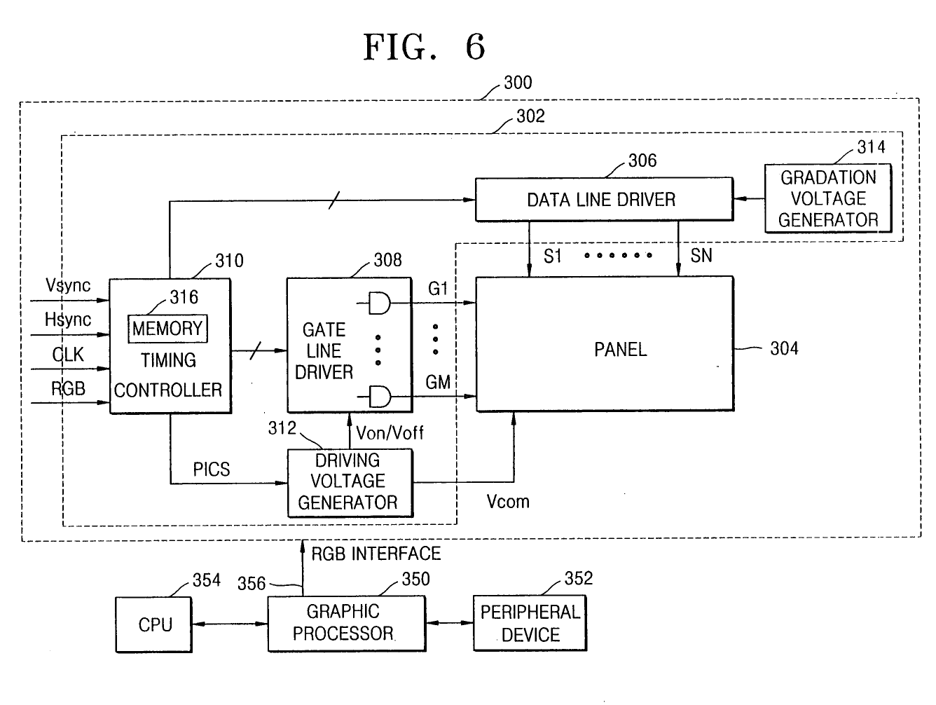

FIG. 6 is a block diagram of a display system incorporating embodiments of the present invention. The circuits described herein and equivalent circuits and/or combinations of circuits and software may provide means for controlling gate line drivers to drive gate lines of a display device in an overlapping block-wise fashion utilizing non-contiguous blocks of gate lines. Furthermore, while the address translation that provides the overlapped block-wise scanning of the gate lines is described herein as provided in a timing controller, as will be appreciated by those of skill in the art in light of the present disclosure, the overlapping block-wise scanning of the gate lines could be provided in other components of the system, such as in the gate line driver and/in the source line driver circuits. Also, a particular addressing ofgate lines could be “hard-wired,” for example by translating the wiring between the gate drivers and the display panel such that the consecutive activation of gate lines results in the desired overlapping block-wise gate scanning pattern.

As seen in FIG. 6, a display device 300 includes a driver circuit 302 and a display panel 304. The display panel 304 may be any display device that utilizes gate lines or other selection lines for controlling access to picture elements (pixels) of the display panel 304. For example, the display panel may be a liquid crystal display (LCD) panel, a plasma display panel, an organic light emitting device (OLED) or other such display panels. In particular embodiments of the present invention, the display panel 304 is a type of panel where the polarity of the gate lines may be inverted so as to avoid “burn-in” or other degradation of the display panel 304. In certain embodiments of the present invention, the polarity of the voltage for driving the display panel may be controlled by a signal, such as V_{com} illustrated in FIG. 6.

As is further illustrated in FIG. 6, the driver circuit 302 may include a data line driver circuit 306 that drives data lines, such as source lines S1 through SN of the display panel 304. A gate line driver circuit 308 drives the gate lines, such as gate lines G1 through GM of the display panel 304. The gate line driver circuit 308 and the data line driver circuit 306 are controlled by a timing controller circuit 310 to drive the gate lines and the data lines in an overlapping block-wise manner according to embodiments of the present invention. The timing controller circuit 310 may also control a driving voltage generator circuit 312 so as to selectively invert the polarity of the gate signals provided to the display panel 304. Additionally, a gradation voltage generator circuit 314 may provide a voltage for application to the data line driver circuit 306. A memory 316 may also be provided associated with the timing controller circuit 310 so as to buffer data provided to the data line driver circuit 306.

In certain embodiments of the present invention, the data line driver circuit 306, the gate line driver circuit 308, the driving voltage generator circuit 312, the display panel 304 and/or the gradation voltage generator circuit 314 may be conventional circuits known to those of skill in the art that are controlled by the timing controller circuit 310 to drive the gate lines in an overlapping block-wise manner. In other embodiments of the present invention, some or all of the functions described with reference to the timing controller 310 may be provided in other components/circuits. Accordingly, embodiments of the present invention should not be construed as limited to the particular arrangement of circuits/components/functions as illustrated in FIG. 6.

The display device 300 may be provided as part of a data processing or other system and receive data for display over an interface, such as an RGB interface 356 from a graphic processor 350 associated with a peripheral device 352 and/or a central processing unit 354. In some embodiments of the present invention, the display device 300 may be incorporated in a single device, such as pervasive computing device, laptop computer, smart appliance, radiotelephone, or may be provided as a separate device or component such as a computer monitor and/or media display monitor, such as a television, home theatre or other such component system. In such embodiments, the particular components, techniques for providing display data and distribution of functions may differ from those illustrated in FIG. 6.

In operation, the timing controller circuit 310 receives RGB data RGB, vertical sync Vsync, horizontal sync Hsync and a clock CLK and uses this information to drive the panel 304. In particular, the Vsync and Hsync may be used to determine a start of frames of data and lines of data within a frame. Thus, the timing controller circuit 310 may use these signals to determine when to drive the data line driver 306 and the gate line driver 308. The timing controller circuit 310 stores 2n lines of data, where n is the number of lines of data in a block, in the memory 316. The timing controller 310 controls the gate lines and provides the data to the data line driver 306 in the blockwise fashion described above, generates the PICS signal that controls the polarity of the Vcom signal based on the block of data being provided to the panel 304.

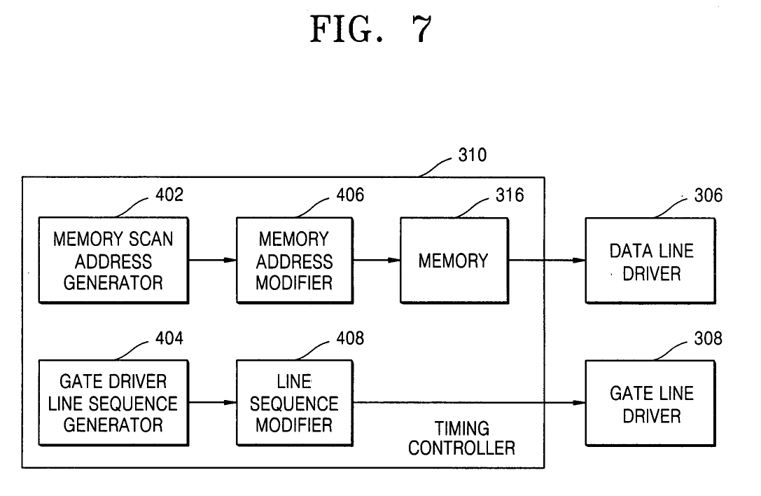

FIG. 7 is a more detailed block diagram of portions of the driver circuit 302 according to some embodiments of the present invention. As seen in FIG. 7, the timing controller circuit 310 may include a memory scan address generator circuit 402 and a gate drive line sequence generator circuit 404. The memory scan address generator circuit 402 may generate sequential addresses for extracting data from the memory 316. A memory address modifier circuit 406 modifies the addresses provided by the memory scan address generator circuit 402 so as to access the memory 316 in an overlapping block-wise manner as described above. The extracted data is then provided to the data line driver circuit 306. A line sequence modifier circuit 408 modifies the sequence of gates to be driven by the gate line driver circuit 308 to correspond to the data provided to the data line driver circuit 306. Likewise, the gate driver line sequence generator circuit 404 may control the PICS signal to invert the polarity of the Vcom signal every n lines. For example, the address modifier circuit 406 and the line sequence modifier circuit 408 may modify sequential addresses and line sequences to provide the sequence illustrated in Table 1 above.

In the embodiments illustrated in FIG. 7, the data for driving the line driver circuit 306 is stored in the memory 316 in line sequence and then extracted from the memory in the overlapping block-wise manner. Alternatively, the data could be stored in the memory 316 in an overlapping block-wise manner and then sequentially extracted from the memory 316. In such a case, the memory address modifier circuit could modify the write address to the memory 316 instead of the read address.

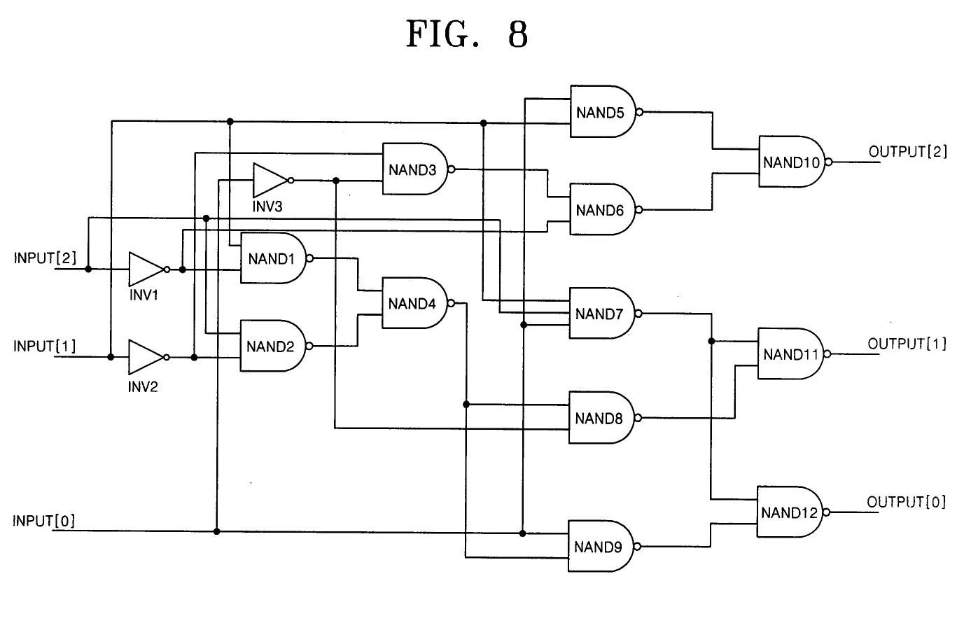

FIG. 8 is a logic diagram illustrating a memory address modification circuit 406 according to some embodiments of the present invention. The logic circuit of FIG. 8 receives as an input address bits as INPUT[0], INPUT[1] and INPUT[2]. The address bits are sequentially incremented from 1 to 6 and are modified to generate the outputs signals OUTPUT[0], OUTPUT[1] and OUTPUT[2]. The output signals sequence 1, 3, 5, 2, 4, 6 so as to extract data from the memory 316 in an overlapping block-wise manner.

As seen in FIG. 8, a first input address bit INPUT[2] is provided to a first inverter INV1 and the output of the first inverter INV1 is provided as an input to a first NAND gate NAND1. A second input address bit INPUT[1] is provided as an input to a second inverter INV2 and the output of the second inverter INV2 is provided as an input to a second NAND gate NAND2. The first input address bit INPUT[2] is also provided as an input to the second NAND gate NAND2 and the second input address bit INPUT[1] is provided as an input to the first NAND gate NAND1. A third input address bit INPUT[0] is provided as an input to a third inverter INV3 and the output of the third inverter INV3 is provided as an input to a third NAND gate NAND3. The output of the second inverter INV2 is also provided as an input to the third NAND gate NAND3.

The output of the first NAND gate NAND1 and the output of the second NAND gate NAND2 are provided as inputs to a fourth NAND gate NAND4. The third input address bit INPUT[0] and the second input address bit INPUT[1] are also provided as inputs to a fifth NAND gate NAND5. The output of the first inverter INV1 and the output of the third NAND gate NAND3 are provided as inputs to a sixth NAND gate NAND6. The third input address bit INPUT[0], the second input address bit INPUT[1] and the first input address bit INPUT[0] are also provided as inputs to a seventh NAND gate NAND7. The output of the third inverter INV3 and the output of the fourth NAND gate NAND4 are provided as inputs to an eighth NAND gate NAND8. The third input address bit INPUT[0] and the output of the fourth NAND gate NAND4 are provided as inputs to a ninth NAND gate NAND9.

The output of the fifth NAND gate NAND5 and the output of the sixth NAND gate NAND6 are provided as inputs to a tenth NAND gate NAND10. The output of the tenth NAND gate NAND10 provides a first output bit OUTPUT[2]. The output of the seventh NAND gate NAND7 and the output of the eighth NAND gate NAND8 are provided as inputs to an eleventh NAND gate NAND11. The output of the eleventh NAND gate NAND11 provides a second output bit OUTPUT[1]. The output of the seventh NAND gate NAND7 and the output of the ninth NAND gate NAND9 are provided as inputs to a twelfth NAND gate NAND12. The output of the twelfth NAND gate NAND12 provides a third output bit OUTPUT [0].

Generically, where k=1 for a block size of n, the address translation may be divided into two segments, a first segment where a count j is incremented from 1 to n and a second segment where the count j is decremented from n to 1. The output of the sequential address counter j′ is sequentially incremented from 1 to 2n. In such a case, the new address d for the first segment corresponding to the first block is:
d=j′+(j−1), for j=1 to n and j′=1 to n; and
for the second segment corresponding to the second block:
d=j′−(j−1), for j=n to 1 and j′=n+1 to 2n.
Such an address translation may be carried out, for example, utilizing parallel arithmetic logic units (ALUs) for the first and second segments, utilizing combinatorial logic, such as that described above, or other techniques known to those of skill in the art.

While embodiments of the present invention have been described with reference to driving gate lines in an overlapping block-wise manner embodiments of the present invention should not be construed as limited to driving gate lines but may be applicable in any display device where lines of the display device are sequentially scanned. Thus, embodiments of the present invention provide for scanning lines of a display in an overlapping blockwise fashion irrespective of the particular technique used to scan an individual line of the display.

Furthermore, embodiments of the present invention have been described with reference to the overlapping blocks being driven consecutively. However, intervening operations may occur between driving or scanning of lines of two overlapping blocks.

While the present invention has been-particularly shown and described with reference to particular embodiments thereof, it will be understood by those of ordinary skill in the art that various changes in form and details may be made therein without departing from the spirit and scope of the present invention as defined by the following claims.

1. A method of scanning lines of a display device, comprising:
scanning the lines of the display device in an overlapping block-wise fashion utilizing non-contiguous blocks of lines of the display device.

2. The method of claim 1, wherein scanning the lines of the display device comprises driving gate lines of the display device in an overlapping block-wise fashion utilizing non-contiguous blocks of gate lines.

3. The method of claim 2, wherein gate lines in the blocks of gate lines includes only non-adjacent gate lines of the display device.

4. The method of claim 2, wherein two consecutive blocks of gate lines include at least one gate line from each of the two blocks that are adjacent gate lines.

5. The method of claim 2, further comprising inverting polarity of the gate lines of consecutive blocks of gate lines for a frame displayed on the display device.

6. The method of claim 5, further comprising inverting polarity of the gate lines of a block of gate lines for consecutive frames displayed on the display device.

7. The method of claim 2, further comprising inverting polarity of the gate lines of a block of gate lines on consecutive frames displayed on the display device.

8. The method of claim 2, wherein individual blocks of the blocks of gate lines include less than half a total number of gate lines of the display.

9. The method of claim 2, wherein blocks of gate lines include n gate lines and the gate lines are spaced apart by k gate lines, where n≧2 and k≧1.

10. The method of claim 9, wherein n=3 and k=1.

11. The method of claim 2, further comprising providing data corresponding to a driven gate line from a memory for driving a source line associated with the driven gate line in a sequence of the overlapping block-wise fashion.

12. The method of claim 11, wherein the data stored in memory is one of stored in a sequence of the overlapping block-wise fashion or read from memory in the sequence of the overlapping block-wise fashion.

13. The method of claim 12, wherein the data stored in memory is written to or read from memory by translating an address j′ that increments from 1 to 2n, where n is the number of lines in a block, to provide a new address d, wherein the address translation comprises translating a first sequence of addresses corresponding to a first block utilizing a first count j, where
d=j′+(j−1), for j=1 to n and j′=1 to n; and
translating a second sequence of addresses corresponding to a second block utilizing the first count j, where
d=j′−(j−1), for j=n to 1 and j′=n+1 to 2n.

14. The method of claim 2, wherein the display device comprises a liquid crystal display.

15. The method of claim 2, wherein the display device comprises an organic light emitting device (OLED).

16. A system for controlling operation of a display device, comprising:
a source driver circuit configured to receive data and drive source lines of the display device based on the received data;
a gate driver circuit configured to selectively drive gate lines of the display device; and
a timing controller circuit configured to receive data for display in the display device, to control the gate driver circuit to selectively drive the gate lines in an overlapping block-wise fashion utilizing non-contiguous blocks of gate lines and to provide the received data corresponding to driven gate lines to the source driver circuit.

17. The system of claim 16, wherein the timing controller circuit is further configured to control a drive voltage generator to invert polarity of the gate lines of consecutive blocks of gate lines for a frame displayed on the display device.

18. The system of claim 17, wherein the timing controller circuit is further configured to control a drive voltage generator to invert polarity of the gate lines of a block of gate lines for consecutive frames displayed on the display device.

19. The system of claim 16, wherein the timing controller circuit is further configured to control a drive voltage generator to invert polarity of the gate lines of a block of gate lines for consecutive frames displayed on the display device.

20. The system of claim 16, wherein the timing controller comprises:
a memory address modifier circuit configured to receive a memory scan address, alter the address according to a sequence of the overlapping block-wise fashion and provide the altered address to a memory so as to store and/or retrieve data for display in the memory in the sequence of the overlapping block-wise fashion; and
a line sequence modifier circuit configured to receive a gate line identifier and alter the gate line identifier according to the sequence of the overlapping block-wise fashion and to provide the altered gate line identifier to the gate driver circuit.

21. The system of claim 20, wherein the memory address modifier circuit is configured to translate the memory scan address j′ that increments from 1 to 2n, where n is the number of lines in a block, to provide an altered address d, wherein the address translation translates a first sequence of addresses corresponding to a first block utilizing a first count j, where
d=j′+(j−1), for j=1 to n and j′=1 to n; and
translates a second sequence of addresses corresponding to a second block utilizing the first count j, where
d=j′−(j−1), for j=n to 1 and j′=n+1 to 2n.

22. The system of claim 20, wherein the memory address modifier circuit comprises:
a first inverter that receives a first input bit of the memory scan address;
a second inverter that receives a second input bit of the memory scan address;
a third inverter that receives a third input bit of the memory scan address;
a first NAND gate that receives an output of the first inverter and the second input bit;
a second NAND gate that receives an output of the second inverter and the first input bit;
a third NAND gate that receives an output of the third inverter and the output of the second inverter;
a fourth NAND gate that receives an output of the first NAND gate and an output of the second NAND gate;
a fifth NAND gate that receives the third input bit and the second input bit;
a sixth NAND gate that receives an output of the third NAND gate and the output of the first inverter;
a seventh NAND gate that receives the first input bit, the second input bit and the third input bit;
an eighth NAND gate that receives an output of the fourth NAND gate and the output of the third inverter;
a ninth NAND gate that receives the output of the fourth NAND gate and the third input bit;
a tenth NAND gate that receives an output of the fifth NAND gate and an output of the sixth NAND gate and output a first output bit of the altered address;
an eleventh NAND gate that receives an output of the seventh NAND gate and an output of the eighth NAND gate and outputs a second output bit of the altered address; and
a twelfth NAND gate that receives the output of the seventh NAND gate and an output of the ninth NAND gate and outputs a third output bit of the altered address.

23. The system of claim 16, wherein the display device comprises a liquid crystal display.

24. The system of claim 16, wherein the display device comprises an organic light emitting device (OLED).

25. The system of claim 16, wherein gate lines in blocks of gate lines includes only non-adjacent gate lines of the display device.

26. The system of claim 16, wherein two consecutive blocks of gate lines include at least one gate line from each of the two blocks that are adjacent gate lines.

27. The system of claim 16, wherein individual blocks of gate lines include less than half a total number of gate lines of the display.

28. The system of claim 16, wherein blocks of gate lines include n gate lines and the gate lines are spaced apart by k gate lines, where n≧2 and k≧1.

29. The system of claim 28, wherein n=3 and k=1.

30. A method of driving gate lines of a display device, comprising:
driving a first subset of the gate lines of the display device, the first subset including a plurality of non-adjacent gate lines; and then
driving a second subset of the gate lines, the second subset including a plurality of gate lines adjacent the gate lines of the first subset; and
inverting a polarity of the voltage applied to the gate lines in the first subset and the gate lines in the second subset.

31. The method of claim 30, wherein at least one of the second subset of gate lines is interspersed with gate lines in the first subset of gate lines.

32. The method of claim 30, further comprising:
inverting the polarity of the voltage applied to the gate lines of the first subset of gate lines from a polarity of the voltage applied to the gate lines of the first subset of gate lines during a previous frame; and
inverting the polarity of the voltage applied to the gate lines of the second subset of gate lines from a polarity of the voltage applied to the gate lines of the second subset of gate lines during the previous frame.

33. The method of claim 30, wherein the display device comprises an liquid crystal display (LCD) device or an organic light emitting device (OLED).

34. The method of claim 30, wherein the first subset of gate lines includes only non-adjacent gate lines of the display device.

35. The method of claim 30, wherein the first subset of gate lines includes less than half a total number of gate lines of the display and the second subset of gate lines includes less than half the total number of gate lines.

36. The method of claim 30, wherein the first and second subset of gate lines each include n gate lines and the gate lines are spaced apart by k gate lines, where n≧2 and k≧1.

37. The method of claim 36, wherein n=3 and k=1.

38. A method of driving gate lines of a display device, comprising:
dividing the gate lines of the display device into blocks of non-adjacent gate lines having k gate lines between gate lines in the block and having n non-adjacent gate lines in a block;
inverting a polarity of a voltage applied to consecutively driven ones of the blocks of non-adjacent gate lines; and
inverting the polarity applied to the blocks of non-adjacent gate lines on consecutive frames of data for display on the display device.

39. The method of claim 38, wherein k is one and n is three.

40. The method of claim 38, wherein the display device comprises an liquid crystal display (LCD) device or an organic light emitting device (OLED).

41. A system for driving gate lines of a display device, comprising:
a plurality of gate line drivers, each gate line driver being associated with a respective gate line of the display device; and
means for controlling the plurality of gate line drivers to drive the gate lines in an overlapping block-wise fashion utilizing non-contiguous blocks of gate lines.

42. The system of claim 41, wherein the display device comprises an liquid crystal display (LCD) device or an organic light emitting device (OLED).
